(19) United States
(12) Patent Application Publication
(10) Pub. No.: US 2024/0273163 A1
(43) Pub. Date: Aug. 15, 2024

(54) ACCELERATOR FOR SPARSE MATRIX MULTIPLICATION IN NEURAL NETWORKS

(71) Applicant: Alibaba Damo (Hangzhou) Technology Co., Ltd., Hangzhou (CN)

(72) Inventors: Yuan GAO, Shanghai (CN); Fei SUN, San Jose, CA (US); Haoran LI, Shanghai (CN); Ruiguang ZHONG, Shanghai (CN)

(21) Appl. No.: 18/441,854

(22) Filed: Feb. 14, 2024

(30) Foreign Application Priority Data
Feb. 15, 2023 (CN) 202310166761.3

(51) Int. Cl. G06F 17/16

(52) U.S. Cl. CPC G06F 17/16

(57) ABSTRACT

This application describes an accelerator, a computer system, and a method for tensor product computation that facilitate circuit designs. The method may include: dividing a weight tensor into a matrix of tiles; shuffling the matrix of tiles in the weight tensor to obtain a shuffled weight tensor; computing a bitmask comprising a matrix of bits corresponding to elements in the shuffled weight tensor; removing the zero elements in the shuffled weight tensor and packing the non-zero elements in the shuffled weight tensor; generating a compact activation tensor based on the bitmask and an activation tensor; and performing tensor multiplication based on the compact weight tensor and the compact activation tensor. The shuffling step effectively reduces the fanout between the activations and the corresponding weights. A reduced fanout may reduce the wiring lengths and thus the energy consumption for signal transmission.

### CROSS-REFERENCE TO RELATED APPLICATIONS

The present application claims priority to Chinese Patent Application No. 202310166761.3, filed on Feb. 15, 2023. The above application is incorporated herein by reference in its entirety.

### TECHNICAL FIELD

The disclosure relates generally to improving the storage and computation efficiency of neural network applications involving sparse matrix multiplication.

### BACKGROUND

Neural networks (NN) are currently the foundation for many modern artificial intelligence (AI) applications such as image and video recognition, recommender systems, classification, medical image analysis, and natural language processing. NNs are employed in various usage scenarios from self-driving cars and detecting cancer to playing complex games. A typical NN may comprise a series of convolution layers where intensive and expensive (computational and energy-wise) convolution operations are performed. A typical convolution layer may involve matrix computations on one or more activation (or input) tensors and one or more weight tensors.

In recent years, various approaches have been developed to improve the computational efficiency of NNs by introducing sparsity to the convolution process in NNs. In some cases, the weight tensors are pruned to reduce the number of non-zero weights, thereby reducing the overall computational cost with a negligible accuracy loss. Various NN accelerators are designed to efficiently store and access the pruned tensors according to the distribution pattern of the zero elements in the pruned tensors. However, under current technologies, the distribution pattern of the zero elements is largely restricted in order to accommodate the design efficiency of the circuit design for the NN accelerators. In this disclosure, a novel hardware-friendly design of a sparse accelerator/engine is described to support more flexible sparsity patterns in sparse matrix computations.

### SUMMARY

Various embodiments of the present specification may include hardware circuitries, systems, methods for efficient sparse matrix multiplications with a hardware-friendly design.

In some aspects, the techniques described herein relate to a computer-implemented method, including: receiving a weight tensor and an activation tensor at a layer in a neural network; dividing the weight tensor into a matrix of tiles; shuffling the matrix of tiles in the weight tensor to obtain a shuffled weight tensor; computing a bitmask including a matrix of bits corresponding to elements in the shuffled weight tensor, wherein each bit includes one bit value indicating whether a corresponding element in the shuffled weight tensor is zero or non-zero; removing the zero elements in the shuffled weight tensor and packing the non-zero elements in the shuffled weight tensor to obtain a compact weight tensor; generating a compact activation tensor based on the bitmask and the activation tensor; and performing tensor multiplication based on the compact weight tensor and the compact activation tensor to generate an output tensor of the layer in the neural network.

In some aspects, the techniques described herein relate to a computer-implemented method, further including: pruning the weight tensor so that a number of non-zero elements in every j continuous elements is within a range between a and b, where j, a, and b are integers, and a<=b<=j.

In some aspects, the techniques described herein relate to a computer-implemented method, wherein j equals to a number of rows within one tile.

In some aspects, the techniques described herein relate to a computer-implemented method, wherein the computing the bitmask including the matrix of bits corresponding to the elements in the weight tensor includes: computing the bitmask based on the pruned weight tensor, wherein each element in the pruned weight tensor corresponds to one bit in the bitmask.

In some aspects, the techniques described herein relate to a computer-implemented method, wherein storing the bitmask and the compact version of the weight tensor consumes less memory space than storing the weight tensor.

In some aspects, the techniques described herein relate to a computer-implemented method, wherein each tile in the matrix of tiles has a same shape of a rectangle or a square.

In some aspects, the techniques described herein relate to a computer-implemented method, wherein the shuffling of the matrix of tiles includes: keeping a first column of the matrix of tiles unchanged; rotating a second column of the matrix of tiles along a column-wise direction by a row-size of a tile; and rotating a third column of the matrix of tiles along the column-wise direction by twice of the row-size of the tile.

In some aspects, the techniques described herein relate to a computer-implemented method, wherein the bitmask includes a matrix of bit tiles respectively corresponding to the matrix of tiles of the weight tensor.

In some aspects, the techniques described herein relate to a computer-implemented method, wherein the generating the compact activation tensor based on the bitmask and the activation tensor includes: dividing a first row of activations in the activation tensor into a plurality of segments, wherein the plurality of segments respectively correspond to a first row of bit tiles in the matrix of bit tiles; and generating one or more first compact rows of activations by replicating one or more activations in the plurality of segments of activations based on non-zero bits in the first row of bit tiles.

In some aspects, the techniques described herein relate to a computer-implemented method, wherein the replicating one or more activations in the plurality of segments of activations based on non-zero bits in the first row of bit tiles includes: for a segment in one of the plurality of segments, identifying the locations of non-zero bits in each column of the corresponding bit tile; replicating the activation corresponding to the non-zero bits in each column of the corresponding bit tile in the first row of bit tiles; and compressing the replicated activations into the one or more first compact rows.

In some aspects, the techniques described herein relate to a computer-implemented method, further including: rotating the plurality of segments in the first row of activations by a size of one segment; generating one or more second compact rows of activations by replicating the plurality of rotated segments of activations based on non-zero bits in a second row of bit tiles; and compressing the one or more first compact rows and the one or more second compact rows into an activation buffer for multiplying with the compact weight tensor.

In some aspects, the techniques described herein relate to a computer-implemented method, wherein the weight tensor includes j columns, and the dividing of the weight tensor into the matrix of tiles divides the j columns into k sections, where k and j are integers, j is divisible by k, and 1<k<j.

In some aspects, the techniques described herein relate to a computer-implemented method, wherein the shuffling of the matrix of tiles in the weight tensor decreases a fanout of each activation by j/k times for reducing power consumptions and signal losses of a circuit designed for multiplying the weight tensor and the activation tensor.

In some aspects, the techniques described herein relate to a hardware accelerator for improving computation efficiency in multiplying a weight tensor and an activation tensor at a layer in a neural network, including: a weight tensor compressing circuit configured to: divide the weight tensor into a matrix of tiles; shuffle the matrix of tiles in the weight tensor to obtain a shuffled weight tensor; and remove zero-valued elements in the shuffled weight tensor and pack the non-zero elements in the shuffled weight tensor to obtain a compact weight tensor; a bitmask generating circuit configured to: compute a bitmask including a matrix of bits corresponding to elements in the shuffled weight tensor, wherein each bit includes one bit value indicating whether a corresponding element in the shuffled weight tensor is zero or non-zero; an activation tensor compressing circuit configured to: generate a compact activation tensor based on the bitmask and the activation tensor; and a computing circuit configured to: perform tensor multiplication based on the compact weight tensor and the compact activation tensor to generate an output tensor of the layer in the neural network.

In some aspects, the techniques described herein relate to a hardware accelerator, wherein the weight tensor is pruned in a way in which a number of non-zero elements in every j continuous elements is within a range between a and b, where j, a, and b are integers, and a<=b<=j, and the j continuous elements are from a same column of one tile.

In some aspects, the techniques described herein relate to a hardware accelerator, wherein to shuffle the matrix of tiles in the weight tensor, the weight tensor compressing circuit is further configured to: keep a first column of the matrix of tiles unchanged; rotate a second column of the matrix of tiles along a column-wise direction by a row-size of a tile; and rotate a third column of the matrix of tiles along the column-wise direction by twice of the row-size of the tile.

In some aspects, the techniques described herein relate to a hardware accelerator, wherein the bitmask includes a matrix of bit tiles respectively corresponding to the matrix of tiles of the weight tensor, and to generate the compact activation tensor based on the bitmask and the activation tensor, the activation tensor compressing circuit is further configured to: divide a first row of activations in the activation tensor into a plurality of segments, wherein the plurality of segments respectively correspond to a first row of bit tiles in the matrix of bit tiles; generate one or more first compact rows of activations by replicating the plurality of segments of activations based on non-zero bits in a first row of bit tiles, wherein the replicating includes: for an i-th activation in one of the plurality of segments, replicating the activation according to the non-zero bits in an i-th row of the bit tile corresponding to the one segment.

In some aspects, the techniques described herein relate to a hardware accelerator, wherein to generate the compact activation tensor based on the bitmask and the activation tensor, the activation tensor compressing circuit is further configured to: rotate the plurality of segments in the first row of activations by a size of one segment; and generate one or more second compact rows of activations by replicating the plurality of rotated segments of activations based on non-zero bits in a second row of bit tiles.

In some aspects, the techniques described herein relate to a hardware accelerator, wherein to generate the compact activation tensor based on the bitmask and the activation tensor, the activation tensor compressing circuit is further configured to the one or more first compact rows and the one or more second compact rows into an activation buffer for multiplying with the compact weight tensor.

These and other features of the systems, methods, and hardware devices disclosed, and the methods of operation and functions of the related elements of structure and the combination of parts and economies of manufacture will become more apparent upon consideration of the following description and the appended claims referring to the drawings, which form a part of this specification, where like reference numerals designate corresponding parts in the figures. It is to be understood, however, that the drawings are for illustration and description only and are not intended as a definition of the limits of the invention.

### BRIEF DESCRIPTION OF THE DRAWINGS

FIG. 1 illustrates an exemplary schematic diagram of a hardware environment for implementing a hardware-friendly tensor product in accordance with some embodiments.

FIG. 2A illustrates an exemplary tensor product computation in neural networks in accordance with some embodiments.

FIG. 2B illustrates a hardware-friendly tensor product pipeline in accordance with some embodiments.

FIG. 2C illustrates a comparison between wirings with a larger fanout and wirings with a smaller fanout in accordance with some embodiments.

FIG. 3 illustrates an exemplary workflow for preprocessing a sparse input tensor with the hardware-friendly tensor product pipeline in accordance with some embodiments.

FIG. 4 illustrates an exemplary hardware-friendly tensor product pipeline in accordance with some embodiments.

FIG. 5 illustrates an exemplary system diagram for implementing the hardware-friendly tensor product pipeline in accordance with some embodiments.

FIG. 6 illustrates an exemplary method of a hardware-friendly tensor product in accordance with some embodiments.

### DETAILED DESCRIPTION

The specification is presented to enable any person skilled in the art to make and use the embodiments, and is provided in the context of a particular application and its requirements.

Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

In neural network (NN) and deep learning (DL) applications, tensor product computation is one of the most fundamental operations to exploit the properties of tensors in order to model associative concepts. A typical tensor product involves multiplying an activation tensor and a weight tensor to extract the features from the activation tensor. In order to improve performance, tensors are often pruned and injected with sparsity to accelerate the tensor product computations without losing noticeable accuracy.

An ideal pruning method should be focused on the semantics and values of the elements in the tensors, rather than on the distribution of the zero elements introduced by the pruning. This type of pruning method may lead to high accuracy and high sparsity, and at the same time a total irregular sparsity in the pruned tensors. Unfortunately, in reality, the distribution of the zero elements introduced by pruning has a direct impact on the design of underlying hardware (e.g., tensor product accelerators or engines). For instance, existing circuit designs suffer from poor efficiency when storing and accessing non-zero elements of tensors with a total irregular distribution of sparsity (e.g., requiring complex logic for addressing the total randomly distributed non-zero elements, causing computing elements (PE) to be idle during computation and lowering the utilization), and thus can barely accelerate the computation. As a result, existing pruning methods often restrict tensor pruning patterns to block sparsity or N:M sparsity.

With block sparsity, a tensor may be divided into blocks/tiles, in which some blocks/tiles are completely pruned into zero elements while other blocks/tiles are not pruned. This coarse-grained pruning method may lead to low sparsity levels and poor computation accuracies (e.g., if 80% of the elements are to be pruned, 20% of remaining elements are restricted to certain blocks). With N:M sparsity, every M elements within N elements (N and M are integers and N>=M) are kept and all other elements (N-M elements) are pruned to zeros. However, the algorithms using N:M sparsity lack flexibility. For instance, certain areas within a tensor may not be important (semantically speaking) for feature extraction, but N:M sparsity algorithms may still have to keep M non-zero elements in these areas. This may lead to low sparsity and accuracy.

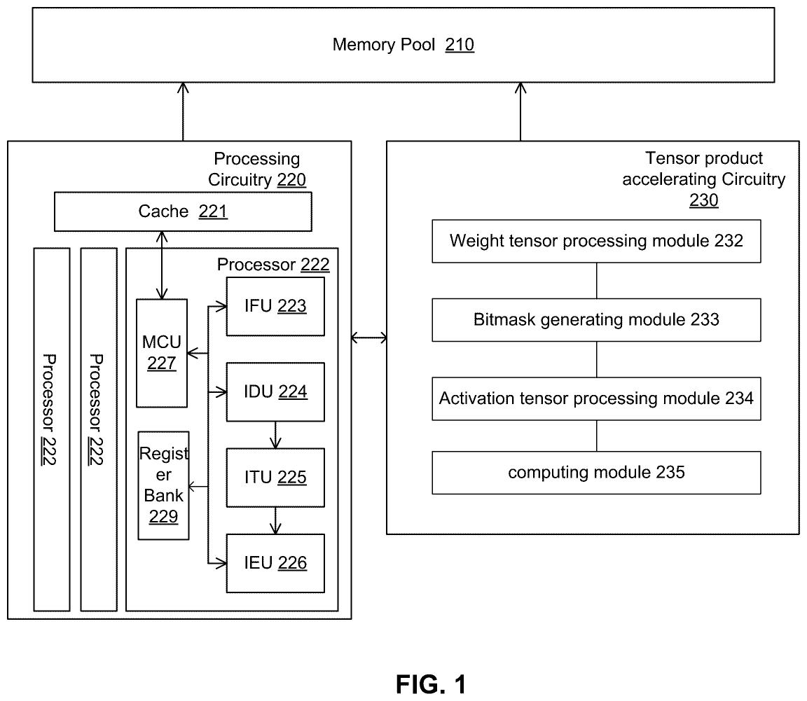

FIG. 1 illustrates an exemplary schematic diagram of a hardware environment for implementing a hardware-friendly tensor product in accordance with some embodiments.

As shown, the hardware environment in FIG. 1 includes a memory pool 210, a processing circuitry 220, and a tensor product accelerating circuitry 230. The layout of the components in the hardware environment is for illustrative purposes, and may be implemented in different ways depending on the actual hardware configuration. In some embodiments, the tensor product accelerating circuitry 230 may be implemented as a standalone hardware accelerator that is separated from the processing circuitry 220 (e.g., one or more CPUs or GPUs). In some embodiments, the tensor product accelerating circuitry 230 may be implemented as a part of the processing circuitry 220 (e.g., a part of one or more CPUs or GPUs) to improve the efficiency of memory management. The memory pool 210 may refer to external storage devices, system RAM, other types of memory resources, or any combination thereof.

In some embodiments, the processing circuitry 220 may include one or more processors 222 and a cache 221 shared by the one or more processors 222. Each processor 222 may include an instruction fetching unit (IFU) 223, an instruction decoding unit (IDU) 224, an instruction transmitting unit (ITU) 225, and an instruction execution unit (IEU) 226.

In some embodiments, the IFU 223 may fetch to-be-executed instructions or data from the memory pool 210 to a register bank 229. In some embodiments, the to-be-executed instructions or data can be fetched into the cache 221 and sent to the IFU 223 via microcontroller unit (MCU) 227. After obtaining the instructions or data, the scheduler 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured to receive the decoded instructions from the IDU 224 and perform instruction scheduling and management. It may efficiently allocate instructions to different IEUs 226 for parallel processing. In some embodiments, after the ITU 225 allocates an instruction to one IEU 226, the IEU 226 may execute the instruction.

In some embodiments, the tensor product accelerating circuitry 230 may receive instructions from processing unit 220, access data from the memory pool 210, and perform tensor product. The tensor product accelerating circuitry 230 may send the tensor product result (e.g., an output tensor) back to the processing unit 220 for continuing the rest of the computations. For instance, the tensor product result corresponding to a neural network (NN) layer may be used as an input for a next tensor product computation in a next layer of the NN. The tensor product accelerating circuitry 230 may be implemented as a hardware accelerator or engine for improving the efficiency of computing tensor products. Here, the improved efficiency may not only include a faster computational speed, but also a smaller memory footprint, and a more hardware-friendly pipeline for circuit design.

In some embodiments, the tensor product accelerating circuitry 230 may include a weight tensor processing module 232, a bitmask generating module 233, an activation tensor processing module 234, and a computing module 235. The following description is based on an assumption that the tensor product computation involves a weight tensor and an activation tensor, in which the weight tensor is being pruned or has been pruned with sparsity, and the activation tensor is either sparse or non-sparse. The assumption may be adjusted to cover other cases in which the activation tensor is being pruned or has been pruned with sparsity and the weight tensor is either sparse or non-sparse. In some embodiments, some modules listed in FIG. 1 may be implemented outside of the tensor product accelerating circuitry 230. For instance, the weight tensor processing module 232 may be implemented in the processing circuitry 220, which means the weight tensor is shuffled and compressed in the processing circuitry 220 before being sent to the tensor shuffling and compressing module 230 for tensor product computation.

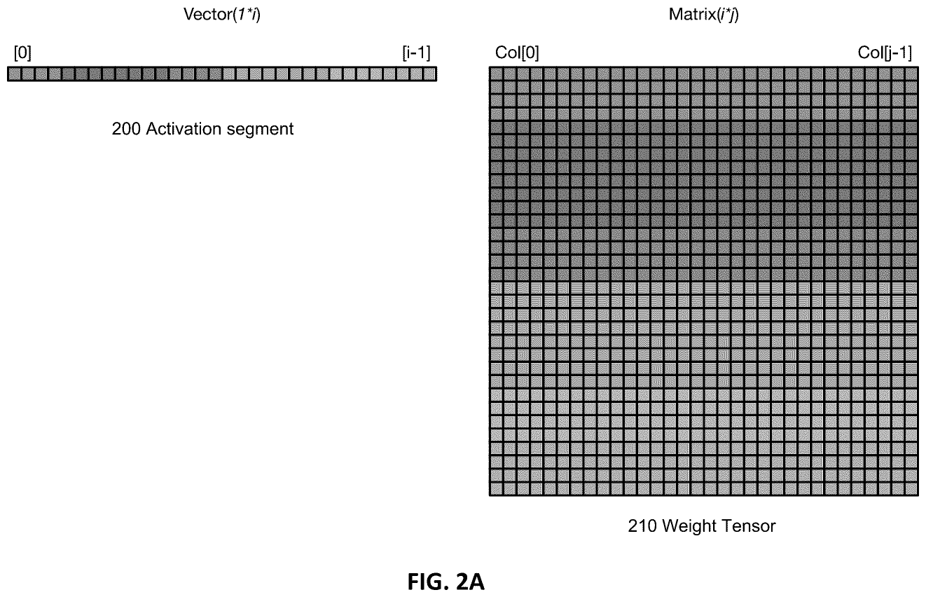

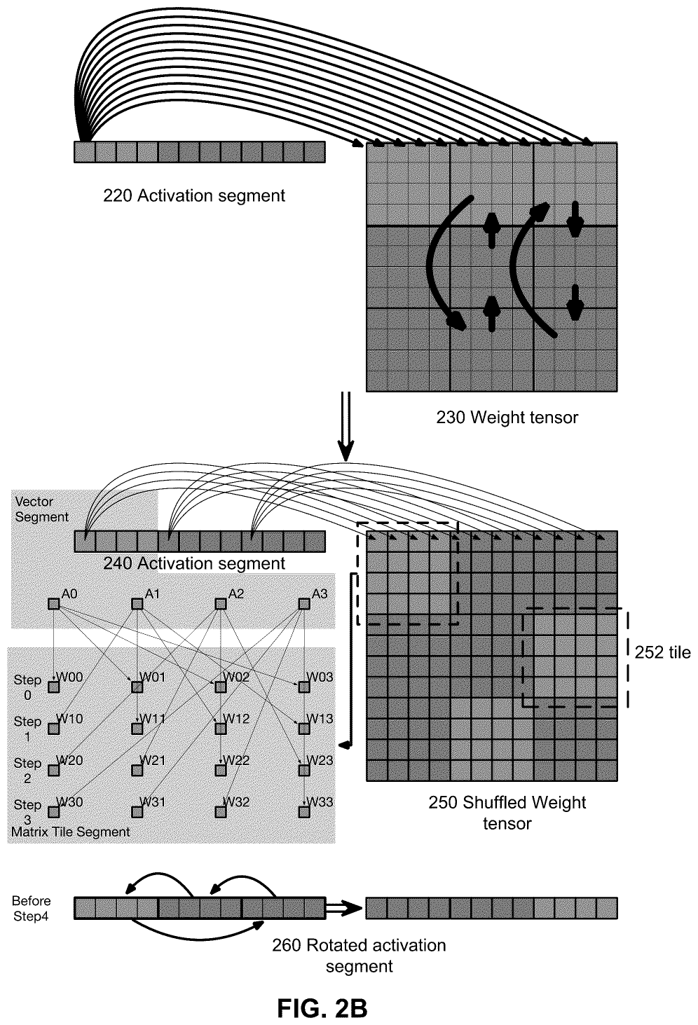

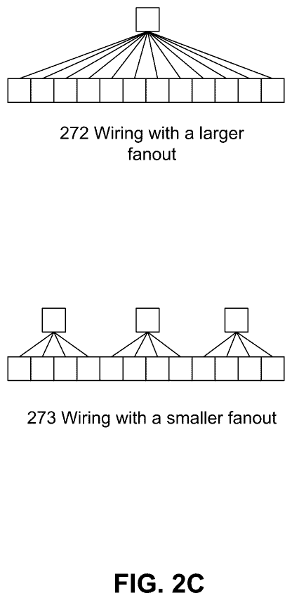

In some embodiments, the weight tensor processing module 232 may be configured to receive a weight tensor and an activation tensor for tensor product computation. The weight tensor and the activation tensor may be from a layer of a neural network, and the computation may be part of a convolution process. In some cases, the weight tensor and/or the activation tensor may be pruned and include zero-valued elements and non-zero-valued elements. The weight tensor processing module 232 may further be configured to divide the weight tensor into a matrix of tiles, and shuffle the matrix of tiles in the weight tensor to obtain a shuffled weight tensor. For instance, the tiles have the same rectangular or square shape, and the shuffling of the matrix of tiles may include: keeping a first column of the matrix of tiles unchanged; rotating a second column of the matrix of tiles along a column-wise direction by a row-size of a tile; and rotating a third column of the matrix of tiles along the column-wise direction by twice of the row-size of the tile. The purpose of the shuffling includes facilitating the circuit design by reducing the fanout for each node (e.g., a register file storing an activation) and reducing the total distance of the wirings. An exemplary shuffling process is further illustrated in FIG. 2B.

In some embodiments, the bitmask generating module 233 may be configured to compute a bitmask with a matrix of bits corresponding to elements in the shuffled weight tensor. Each bit in the bitmask comprises one bit value indicating whether a corresponding element in the shuffled weight tensor is zero or non-zero.

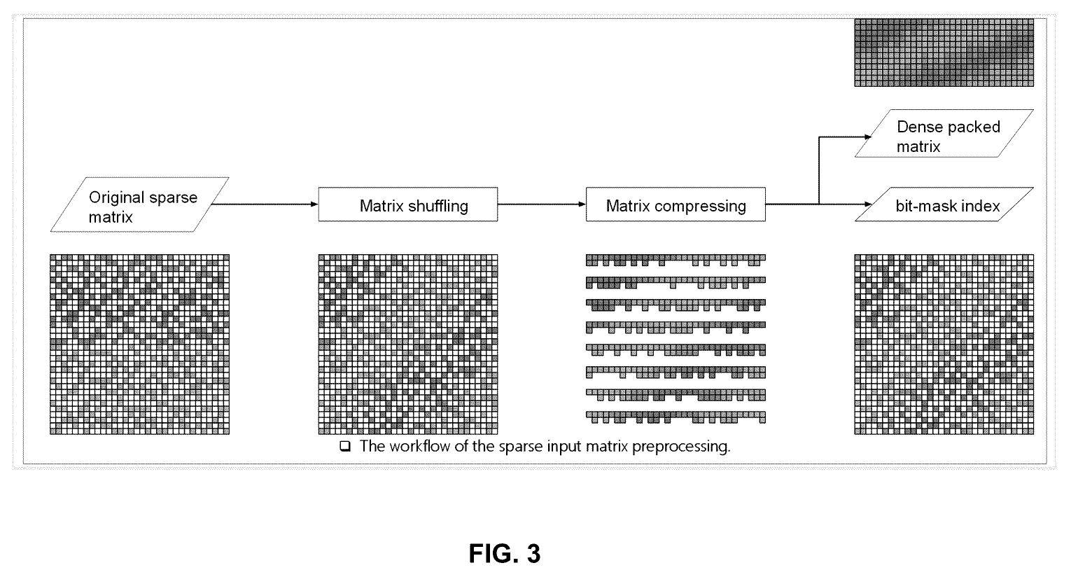

In some embodiments, after the bitmask is computed based on the shuffled weight tensor, the weight tensor processing module 232 may be further configured to remove the zero elements in the shuffled weight tensor and pack the non-zero elements in the shuffled weight tensor to obtain a compact weight tensor. The “packing” here may refer to removing any spaces that are occupied by zero-valued weights. In some embodiments, removing one space occupied by a zero weight may include shifting the rest of the weights in the same column up by one space. An illustrative process of packing the weight tensor may refer to FIG. 3.

While the bitmask provides the location information of the non-zero elements in the shuffled weight tensor, the compact weight tensor provides the actual non-zero values without storing any of the zero-valued elements or their corresponding indices. Thus the bitmask and the compact weight tensor may be used collaboratively to reconstruct the full information of the original weight tensor with a smaller memory storage footprint. In many cases, storing the bitmask and the compact version of the weight tensor consumes less memory space than storing the weight tensor. For instance, each element (zero or non-zero) in the original weight tensor may consume 32 bits (e.g., 4 bytes for integers), and each element in the bitmask consumes 1 bit.

Assuming the original weight tensor includes X elements with x non-zero elements, storing the original weight tensor consumes 32X bits, while storing the bitmask and the compact weight tensor consumes X+32x. It means as long as the sparsity of the pruned weight tensor is greater than 5%, storing the bitmask and the compact weight tensor would save the memory space.

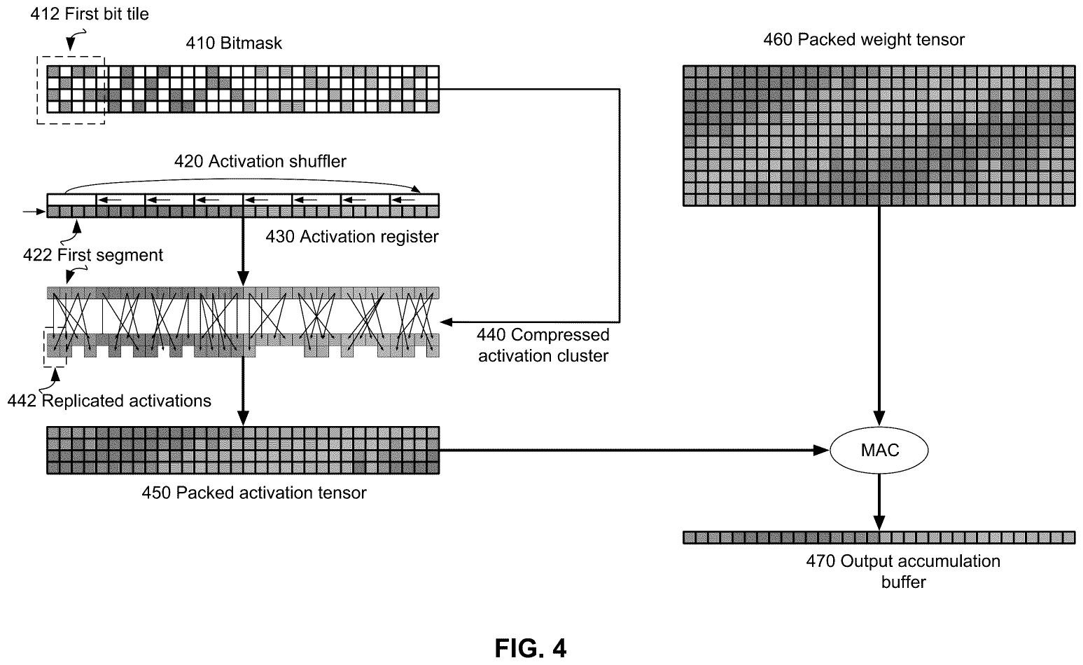

In some embodiments, the activation tensor processing module 234 may be configured to generate a compact activation tensor based on the bitmask and the original activation tensor. Note that the compact activation tensor is generated differently from the compact weight tensor. The compact weight tensor is generated by pruning the zero-valued elements and packing (e.g., compressing) the non-zero-valued elements into a compact form. The compact activation tensor, on the other hand, is generated based on the non-zero bits in the bitmask. For instance, if an activation corresponds to a zero-valued bit in the bitmask, it will be pruned out (removed); if an activation corresponds to a non-zero bit in the bitmask, it will be retained. With this approach, the activations being pruned out from the activation tensor may include non-zero-valued activations, and the activations being retained in the compact activation tensor may also include zero-valued activations. In other words, the pruning process only keeps the activations that need to be multiplied with non-zero weights in the weight tensor, and abandons the activations that correspond to zero-valued weights in the compact weight tensor. The activations after pruning may then be compressed or packed into the compact activation tensor. The “packing” here may refer to: after pruning out an activation element, shifting the rest of the activations from the same column up by one element. An illustrative process of packing the activation tensor may refer to FIG. 4.

In some embodiments, the computing module 235 may be configured to perform tensor multiplication and addition (MAC operations) based on the compact weight tensor and the compact activation tensor to generate an output tensor of the layer in the neural network. Since the two operators, the compact weight tensor and the compact activation tensor, are all in a compact format, the output tensor may also be in a compact format. In some embodiments, if the compact output tensor needs to be decompressed, the bitmask may be used to insert the zero-valued elements for reconstructing the non-compressed output tensor. In some embodiments, the compact output tensor along with the bitmask may be input into a next layer of a neural network for a next round of computation.

FIG. 2A illustrates an exemplary tensor product computation in neural networks in accordance with some embodiments. The diagram in FIG. 2A breaks down a matrix-matrix multiplication between two matrices into a simple vector-matrix multiplication for ease of description. As shown, the vector (1*i) refers to an activation segment 200, which may refer to a row or a partial row of activations of an activation tensor. The matrix(i*j) refers to a weight tensor 210. Text-book matrix multiplication may include multiplying the activation segment 200 with each column of weights in the weight tensor 210. In particular, the multiplication involves multiplying each activation in the activation segment 200 with the corresponding weight in the weight tensor 210 and adding all the products together to generate one element for an output vector. This means that each activation in the activation segment 200 may be multiplied with j weights from the corresponding row in the weight tensor 210. For instance, the first activation vector[0] may be multiplied with all the weights in the first row of the weight tensor 210. For this reason, the fanout for the first activation (as well as any other activation) in the activation segment is j. In the context of circuit design, to minimize the overall wiring distance and the power consumption (e.g., power consumption due to the wiring distance), the register file storing the first activation may be placed in the middle of the register files storing the first row of weights. However, with this design, the distances between the first activation and the first and last weights in the first row of weights are much longer than the distance between the first activation and the weight in the middle of the row, and transmitting signals over a longer distance would consume more power and may also cause various timing issues (e.g., requiring more complex clock synchronization). FIG. 2B illustrates an improved approach to reduce the fanout and thereby reducing the power consumption and the chances of various timing issues or even signal loss.

FIG. 2B illustrates a hardware-friendly tensor product pipeline in accordance with some embodiments. Note that the design illustrated in FIG. 2B includes tiling a tensor into tiles and shuffling the tiles for facilitating hardware designs. This pipeline may be applicable to tensors with or without sparsity. For simplicity, the description for FIG. 2B ignores the sparsity within the tensors, and focuses on the tiling and shuffling process. FIGS. 3 and 4 may apply the design to use cases involving at least a sparse weight tensor.

In some embodiments, one of the two tensors involved in a tensor product computation may be divided into tiles. As an example in FIG. 2B, the weight tensor 230 is divided into a plurality of tiles 252. The weight tensor 230 is a 12*12 matrix, each tile 252 is a 4*4 tile, and thus the weight tensor 230 is divided into a 3*3 matrix of tiles 252. The matrix of tiles 252 may then be shuffled to reduce the fanout of each activation in the activation segment 220 during the tensor product computation. The description for FIG. 2A explained that, without shuffling, each activation in the activation segment 220 may be copied (e.g., using an amplifier) to all weights in the corresponding row for multiplication and addition, in which case the fanout for each activation is the row size of the weight tensor 230 (in this example, 12).

In some embodiments, the shuffling of the tiles 252 may include: keeping a first column of the matrix of tiles unchanged; rotating a second column of the matrix of tiles along a column-wise direction by a row-size of a tile; and rotating a third column of the matrix of tiles along the column-wise direction by twice of the row-size of the tile, and so on. The shuffling is illustrated by the change from the weight tensor 230 to the shuffled weight tensor 250 in FIG. 2B. After shuffling, the first activation (A0, where “A” refers to activation) in the activation segment 240 may only need to be copied to the four weights in the first row of the first tile (w[0,0], w[0,1], w[0,2], and w[0,3], where “w” refers to weight, the first index refers to the row index and the second index refers to the column index); similarly, activation A1 needs to be copied to weights w[1,0]-w[1,3], activation A2 needs to be copied to weights w[2,0]-w[2,3], and activation A3 needs to be copied to weights w[3,0]-w[3,3]; and the fifth activation in the activation segment 240 may only need to be copied to the four weights in the first row of the second tile. Thus, the fanout of each activation in the activation segment 240 is reduced to the row size of the tile rather than the row size of the weight tensor 250 (in this example, 4).

With the smaller fanout, the activation A0 may be stored in a register file that is placed in the middle of the register files storing w[0,0]-w[0,3], the activation A4 may be stored in a register file that is placed in the middle of the register files storing w[0,4]-w[0,7], and the activation A8 may be stored in a register file that is placed in the middle of the register files storing w[0,8]-w[0,11]. The example wiring is shown as the writing with a smaller fanout 273 in FIG. 2C. In comparison, with the larger fanout (without performing the shuffling), A0 needs to be stored in a register file that is placed in the middle of the register files storing w[0,0]-w[0,11], in which the distances between A0 and the weights on the two ends are much greater than the distances between A0 and the weights in the middle. The example wiring is shown as the wiring with a larger fanout 272 in FIG. 2C. As shown in FIG. 2C, the average distance between the activation and the weights is smaller in the wiring with a smaller fanout 273 compared to that in the wiring with a larger fanout 272. Therefore, the wire placement under the smaller fanout effectively reduces the total wiring distance between the activations and the corresponding weights. As transferring signals over longer wires may consume more power and cause higher latencies, the wiring with a smaller fanout may save the total power consumption and reduce the chances of various timing issues or even signal loss.

In some embodiments, after the activation segment 240 is multiplied with a first row of tiles in the shuffled weight tensor 250, it may be shuffled before being multiplied with a next row of tiles. As shown in FIG. 2B, the activation segment 240 may be divided into sections based on the row size of the tiles in the shuffled weight tensor 250, and the sections may be rotated in one direction by the size of the section to obtain a rotated activation segment 260. The sections in the rotated activation segment 260 are respectively correspond to the next row of tiles for the purpose of tensor computation.

FIG. 3 illustrates an exemplary workflow for preprocessing a sparse input tensor with the hardware-friendly tensor product pipeline in accordance with some embodiments. In some embodiments, the “preprocessing” may imply that the workflow in FIG. 3 may be implemented outside of a tensor product computation accelerator, i.e., before the tensor computation between the tensors is actually performed. In other embodiments, the “preprocessing” may be implemented as part of the tensor product computation accelerator.

As shown in FIG. 3, after receiving a sparse tensor (or a matrix), tiling operations may be performed to divide the sparse tensor into a matrix of tiles. The tiles may have the shape of a rectangle or a square. As an example, the sparse tensor is a weight tensor from a neural network layer. The weight tensor may have j columns, and the dividing of the weight tensor into the matrix of tiles includes dividing the j columns into k sections (each section corresponds to a tile), where k and j are integers, j is divisible by k, and 1<k<j.

In some embodiments, the matrix of tiles in the weight tensor may be shuffled to decrease a fanout of each activation in the activation tensor by j/k times for reducing power consumption and signal losses of a circuit designed for multiplying the weight tensor and the activation tensor. An exemplary shuffling process is explained in detail in FIG. 2B.

After shuffling, the weight tensor may then be compressed/packed. The compression comprises two phases: (1) compression within each row of the tiles, and (2) compression across different rows of tiles. During the phase of compression within each row of the tiles, each row of tiles is compressed locally. For instance, in the first row of tiles, all zero-valued weights are removed, and all the remaining non-zero weights are compressed in the column direction so that no space between any two non-zero weights is in the same column within the row of tiles. During the phase of compression across different rows of tiles, the locally compressed rows of tiles are further compressed in the column direction so that no space between any two non-zero weights exists in the same column. The outcome of the compression includes a dense-packed weight tensor.

While the dense-packed weight tensor includes all the non-zero weights, the location information of these non-zero weights is also needed for executing the computation properly. For this reason, a bitmask may be constructed based on the shuffled weight tensor. The bitmask may be the same size as the shuffled weight tensor, and includes a plurality of bits respectively corresponding to the plurality of weights (zeros or non-zeros) in the shuffled weight tensor. Each bit may use a binary value to represent whether the corresponding weight is a zero or non-zero. Since each element in the bitmask only occupies one bit of memory space, the bitmask is lightweight.

In some embodiments, at the beginning of the workflow illustrated in FIG. 3, the received tensor may go through a pruning process to zero out the non-essential features (e.g., weights smaller than a threshold may be pruned out). The pruning method may be designed to further facilitate the performance of the workflow, e.g., the received tensor may be pruned so that the generated dense-packed matrix is a rectangular shape. For instance, the pruning may include pruning the weight tensor so that, after pruning, a number of non-zero elements in every j continuous elements within the same column is within a range between a and b, where j, a, and b are integers, and a<=b<=j, and the j equals to a number of rows within one tile. As shown in FIG. 3, each tile is a 4*4 square (4 rows), and the input tensor is pruned so that every four-element column has 1 to 2 non-zero elements. In this case, j=4, a=1, and b=2.

FIG. 4 illustrates an exemplary hardware-friendly tensor product pipeline in accordance with some embodiments. The process illustrated in FIG. 4 is based on a presumption that a weight tensor has been tiled (into tiles), shuffled (based on the tiles), and compressed into the packed weight tensor 460, and the bitmask 410 has been computed (based on the tiled and shuffled weight tensor before compression).

As described above, the bitmask 410 includes a matrix of bits respectively corresponding to the elements in the tiled and shuffled weight tensor, and may be used to generate a compact activation tensor based on the original activation tensor. In some embodiments, each row of the original activation tensor (stored in the activation register 430) may be used to construct a plurality of rows of compact activations based on the bitmask 410. The bitmask may be treated as a matrix of bit tiles respectively corresponding to the matrix of tiles of the (tiled and shuffled) weight tensor, and each row of bit tiles may be used as a guide to select activations from the row of activations. The selected activations may form the compressed activation cluster 440. For instance, the compact activation tensor may be constructed by: dividing a first row of activations in the activation tensor into a plurality of segments, wherein the plurality of segments respectively correspond to a first row of bit tiles in the matrix of bit tiles; and generating one or more first compact rows of activations by replicating the plurality of segments of activations based on non-zero bits in a first row of bit tiles. The replicating may include: for a segment in one of the plurality of segments, identifying the locations of non-zero bits in each column of the corresponding bit tile; replicating the activation according to the non-zero bits in each column of the corresponding bit tile; and compressing the replicated activations into the one or more first compact rows.

Using the diagram in FIG. 4 as an example, the row of bit tiles from the bitmask 410 includes eight 4*4 bit tiles, and the row of activations is divided into a plurality of segments with each segment including 4 activations. The first segment 422 corresponds to the first bit tile 412. For the first segment 422, the first column of the bit tile 412 is examined, in which the first bit and the third bit are non-zeros. Based on the non-zero bits in the first column of the bit tile 412, the first activation and the third activation in the first segment 422 are replicated and compressed into the first column 442 of the compressed activation cluster 440. Then the second column of the bit tile 412 is examined, in which the second and the fourth bits are non-zero. Then the corresponding second and fourth activations from the segment are replaced and compressed into the second column of the compressed activation cluster 440. The process continues until all the columns in the first bit tile 412 is examined. Then the process proceeds with the next segment in the activation register 430.

In some embodiments, after the first row of the activations stored in the activation register 430 is processed (used to construct the first few rows of the compressed activation cluster 440 based on the bitmask 410), the row of the activations may be shuffled by an activation shuffler 420 to match the next row of bit tiles and generate the next few rows of the compressed activation cluster 440.

The compressed activation clusters 440 generated from multiple iterations may then be compressed into a packed activation tensor 450. This packed activation tensor 450 includes all the activations corresponding to non-zero bits in the bitmask 410, in which the activations may include zeros and non-zeros. The packed activation tensor 450 and the packed weight tensor 460 may then be sent to a Multiplication-Accumulation (MAC) gate for computation. The MAC gate may generate an output tensor stored in the output accumulation buffer 470 for subsequent computations.

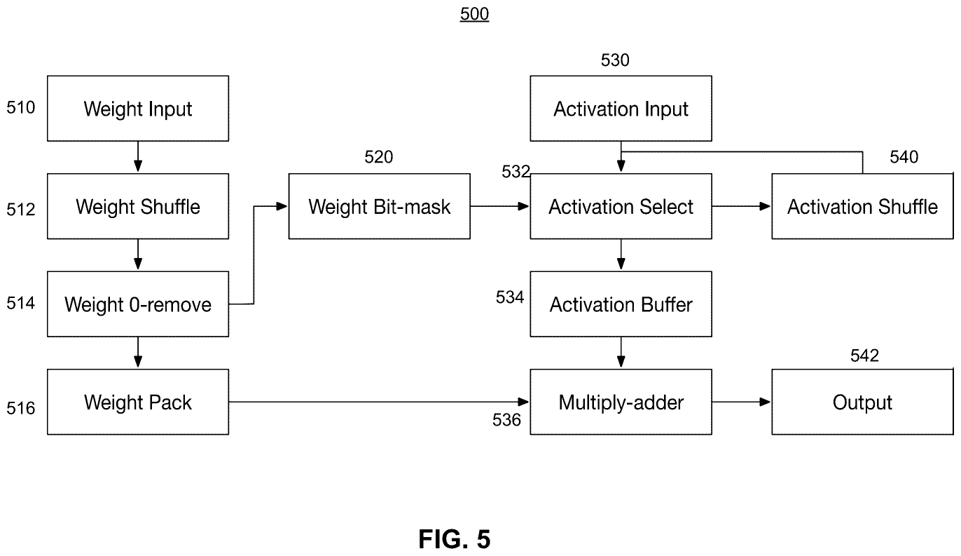

FIG. 5 illustrates an exemplary system diagram 500 for implementing the hardware-friendly tensor product pipeline in accordance with some embodiments. The components in the system diagram 500 are for illustrative purposes only. Depending on the implementation, the system diagram 500 may include more, fewer, or alternative components. In some embodiments, the system diagram 500 may refer to a pipeline for conducting tensor product computation between a weight tensor and an activation tensor, for example, at a layer within a neural network. The pipeline transforms the weight tensor and the activation tensor in a way to reduce fanout in the circuit design. Within the context of integrated circuit (IC) designs, the “fanout” may refer the maximum number of digital inputs that the output of a single logic gate can feed/drive. The reduced fanout is helpful in reducing the overall power consumption of the circuit, lowering the signal propagation delays, and reducing the probability of signal timing issues or even signal loss issues.

In some embodiments, the system diagram 500 may include a weight input module 510 for receiving a weight tensor. In some embodiments, the weight tensor may have already been pruned into a sparse tensor. In some embodiments, the weight input module 510 may implement the pruning. The pruning process may include: dividing the weight tensor into a matrix of tiles, pruning the weight tensor so that a number of non-zero elements in every j continuous elements is within a range between a and b, where j, a, and b are integers, and a<b<=j, and j equals to a number of rows within one tile. This way of pruning provides more flexibility than the existing pruning methods with N:M sparsity. In particular, the existing pruning methods with N:M sparsity requires keeping M non-zeros within every N elements, regardless of whether the N elements are located in essential areas or non-essential areas within the weight tensor. Here, the “essential” and “non-essential” refer to whether the corresponding features are important or not (e.g., edge/corner features are important/essential for object detection). In contrast, the above-described pruning method allows pruning the tiles in the non-essential areas with a higher degree, i.e., keeping a smaller number of non-zeros (e.g., using the lower end of the range, a), and pruning the tiles in the essential areas within the weight tensor with a less degree, i.e., keeping a greater number of non-zeros (e.g., using the higher end of the range, b). In some embodiments, information surrounding essential or non-essential areas corresponding to the weight tensor may be received by the weight input module 510 or other modules in system diagram 500 (e.g., together with the weight tensor).

In some embodiments, the pruned weight tensor may be shuffled in the weight shuffle module 512. The shuffling may include: shuffling different columns of tiles within the weight tensor with different distances. For instance, after the weight tensor is segmented into a matrix of weight tiles, the shuffling may include keeping a first column of the matrix of tiles unchanged; rotating a second column of the matrix of tiles along a column-wise direction by a row-size of a tile; and rotating a third column of the matrix of tiles along the column-wise direction by twice of the row-size of the tile. This process may continue until all columns (except for the first column) of tiles are shuffled. The shuffling helps reducing the fanout between each activation and the corresponding weights. More details may refer to FIG. 2B.

After pruning and shuffling the weight tensor, a bitmask may be generated by the weight bitmask module 520. The bitmask may include a matrix of bits corresponding to elements in the shuffled weight tensor, and each bit comprises one bit value indicating whether a corresponding element in the shuffled weight tensor is zero or non-zero. In some embodiments, the bits in the bitmask may be further segmented into bit tiles respectively corresponding to the tiles within the shuffled weight tensor. The bit tiles may be used later for constructing a packed activation tensor.

The weight remove module 514 may remove the zero-valued elements in the shuffled weight tensor. The removal may be performed iteratively throughout all rows of the weight tensor. After each zero-valued element is removed, the remaining elements in the same column (below the removed element) in the weight tensor may shift up to take the space occupied by the removed element.

After all zero-valued elements are removed from the shuffled weight tensor, the weight pack module 516 may obtain the packed weight tensor (a compressed version of the shuffled weight tensor). The packed weight tensor maintains the non-zero elements in the shuffled weight tensor. Storing the bitmask and the packed weight tensor consumes a less memory space than storing the shuffled weight tensor if the shuffled weight tensor is sparse.

While the weight tensor is being processed through the modules 510, 512, 514, 516, and 520, the activation tensor may also be processed in parallel. For instance, the activation input module 530 obtains the activation tensor. The described method/system does not require the activation tensor to be sparse. The activation tensor may be compressed based on the bitmask at the activation select module 532. The bitmask stores the location information of the non-zero weights in the shuffled weight tensor, and the weight tensor is shuffled based on the weight tiles. The compression of the activation tensor at the activation select module 532 may include: dividing a first row of activations in the activation tensor into a plurality of segments, wherein the plurality of segments respectively correspond to a first row of bit tiles in the matrix of bit tiles; and generating one or more first compact rows of activations by replicating the plurality of segments of activations based on non-zero bits in a first row of bit tiles. In some embodiments, the replicating the plurality of segments of activations based on non-zero bits in the first row of bit tiles includes: for a segment in one of the plurality of segments, identifying the locations of non-zero bits in each column of the corresponding bit tile in the first row of bit tiles; replicating the activation according to the non-zero bits in each column of the corresponding bit tile; and compressing the replicated activations into the one or more first compact rows.

In some embodiments, before generating more compact rows of activations using the second row of bit tiles and the first row of the activations, the first row of activations may be rotated/shuffled by a size of one segment using an activation shuffle module 540. After the rotation, more compact rows of activations may be generated by replicating the plurality of rotated segments of activations based on non-zero bits in a second row of bit tiles. The one or more first compact rows and the one or more second compact rows may then be compressed into an activation buffer 534 as a packed activation tensor.

After the packed activation tensor and the packed weight tensor are ready, they may be fed into a multiply-adder module 536 for performing the computation (e.g., multiplications and additions) to generate an output tensor into the output module 542. In some embodiments, the output tensor may be used as an input for a next layer of the neural network.

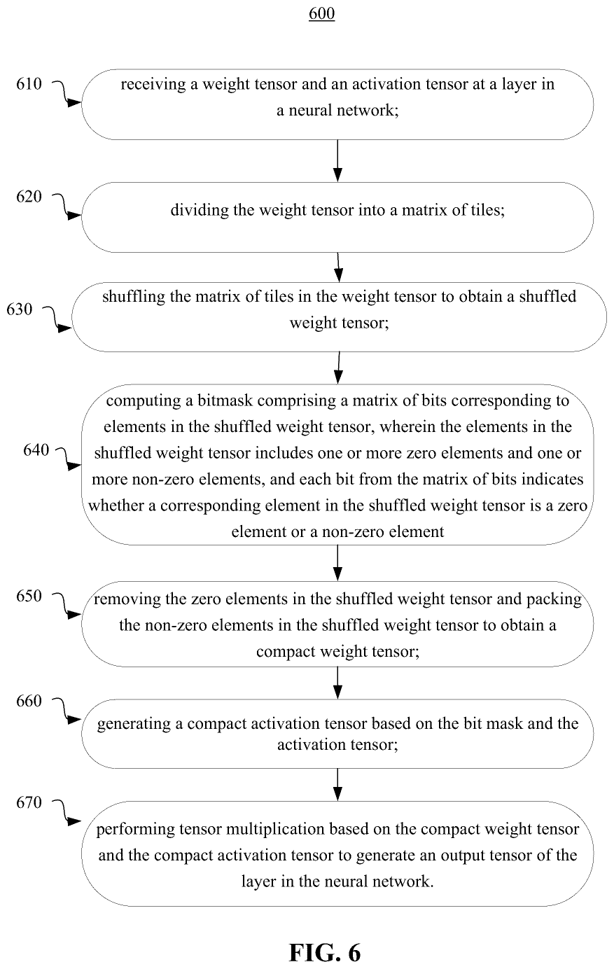

FIG. 6 illustrates an exemplary method 600 of a hardware-friendly tensor product in accordance with some embodiments. Method 600 may be implemented in an environment shown in FIG. 1. Method 600 may be performed by a device, apparatus, or system illustrated by FIGS. 1-5, such as the tensor product accelerating circuitry 230 in FIG. 1. Depending on the implementation, method 600 may include additional, fewer, or alternative steps performed in various orders or parallel.

Block 610 of method 600 includes receiving a weight tensor and an activation tensor at a layer in a neural network.

Block 620 of method 600 includes dividing the weight tensor into a matrix of tiles.

Block 630 of method 600 includes shuffling the matrix of tiles in the weight tensor to obtain a shuffled weight tensor. In some embodiments, each tile in the matrix of tiles has a same shape of a rectangle or a square. In some embodiments, the shuffling of the matrix of tiles comprises: keeping a first column of the matrix of tiles unchanged; rotating a second column of the matrix of tiles along a column-wise direction by a row-size of a tile; and rotating a third column of the matrix of tiles along the column-wise direction by twice of the row-size of the tile. In some embodiments, the weight tensor comprises j columns, and the dividing of the weight tensor into the matrix of tiles includes dividing the j columns into k sections, where k and j are integers, j is divisible by k, and 1<k<j. In some embodiments, the shuffling of the matrix of tiles in the weight tensor decreases a fanout of each activation by j/k times for reducing power consumption and signal losses of a circuit designed for multiplying the weight tensor and the activation tensor.

Block 640 of method 600 includes computing a bitmask comprising a matrix of bits corresponding to elements in the shuffled weight tensor, wherein each bit comprises one bit value indicating whether a corresponding element in the shuffled weight tensor is zero or non-zero. In some embodiments, the bitmask comprises a matrix of bit tiles respectively corresponding to the matrix of tiles of the weight tensor.

Block 650 of method 600 includes removing the zero elements in the shuffled weight tensor and packing the non-zero elements in the shuffled weight tensor to obtain a compact weight tensor.

Block 660 of method 600 includes generating a compact activation tensor based on the bitmask and the activation tensor. In some embodiments, the generating the compact activation tensor based on the bitmask and the activation tensor comprises: dividing a first row of activations in the activation tensor into a plurality of segments, wherein the plurality of segments respectively correspond to a first row of bit tiles in the matrix of bit tiles; and generating one or more first compact rows of activations by replicating one or more activations in the plurality of segments of activations based on non-zero bits in the first row of bit tiles. In some embodiments, the replicating one or more activations in the plurality of segments of activations based on non-zero bits in the first row of bit tiles comprises: for a segment in one of the plurality of segments, identifying the locations of non-zero bits in each column of the corresponding bit tile; replicating the activation corresponding to the non-zero bits in each column of the corresponding bit tile in the first row of bit tiles; and compressing the replicated activations into the one or more first compact rows. In some embodiments, the method 600 may further include: rotating the plurality of segments in the first row of activations by a size of one segment; generating one or more second compact rows of activations by replicating the plurality of rotated segments of activations based on non-zero bits in a second row of bit tiles; and compressing the one or more first compact rows and the one or more second compact rows into an activation buffer for multiplying with the compact weight tensor.

Block 670 of method 600 includes performing tensor multiplication based on the compact weight tensor and the compact activation tensor to generate an output tensor of the layer in the neural network.

In some embodiments, method 600 may further include: pruning the weight tensor so that a number of non-zero elements in every j continuous elements is within a range between a and b, where j, a, and b are integers, and a<=b<=j, and j equals to a number of rows within one tile. In some embodiments, the computing the bitmask is based on the pruned weight tensor, wherein each element in the pruned weight tensor corresponds to one bit in the bitmask.

In some embodiments, storing the bitmask and the compact version of the weight tensor consumes less memory space than storing the weight tensor.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor-executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, where the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may include program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code that include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method, comprising:
receiving a weight tensor and an activation tensor at a layer in a neural network;
dividing the weight tensor into a matrix of tiles;
shuffling the matrix of tiles to obtain a shuffled weight tensor;
computing a bitmask comprising a matrix of bits corresponding to elements in the shuffled weight tensor, wherein the elements in the shuffled weight tensor includes one or more zero elements and one or more non-zero elements, and each bit from the matrix of bits indicates whether a corresponding element in the shuffled weight tensor is a zero element or a non-zero element;
removing the zero elements in the shuffled weight tensor and packing the non-zero elements in the shuffled weight tensor to obtain a compact weight tensor;
generating a compact activation tensor based on the bitmask and the activation tensor; and
performing tensor multiplication based on the compact weight tensor and the compact activation tensor to generate an output tensor of the layer in the neural network.

2. The computer-implemented method of claim 1, further comprising:
pruning the weight tensor so that a number of non-zero elements in every j continuous elements is within a range between a and b, where j, a, and b are integers, and a<=b<=j.

3. The computer-implemented method of claim 2, wherein j equals a number of rows within one tile.

4. The computer-implemented method of claim 2, wherein the computing of the bitmask comprises:
computing the bitmask based on the pruned weight tensor, wherein each element in the pruned weight tensor corresponds to one bit in the bitmask.

5. The computer-implemented method of claim 1, wherein storing the bitmask and the compact version of the weight tensor consumes less memory space than storing the weight tensor.

6. The computer-implemented method of claim 1, wherein each tile in the matrix of tiles has a same shape of a rectangle or a square.

7. The computer-implemented method of claim 1, wherein the shuffling of the matrix of tiles comprises:
keeping a first column of the matrix of tiles unchanged;
rotating a second column of the matrix of tiles along a column-wise direction by a row size of a tile; and
rotating a third column of the matrix of tiles along the column-wise direction by twice of the row size of the tile.

8. The computer-implemented method of claim 1, wherein the bitmask comprises a matrix of bit tiles respectively corresponding to the matrix of tiles of the weight tensor.

9. The computer-implemented method of claim 8, wherein the generating the compact activation tensor based on the bitmask and the activation tensor comprises:
dividing a first row of activations in the activation tensor into a plurality of segments, wherein the plurality of segments respectively correspond to a first row of bit tiles in the matrix of bit tiles; and
generating one or more first compact rows of activations by replicating one or more activations in the plurality of segments of activations based on non-zero bits in the first row of bit tiles.

10. The computer-implemented method of claim 9, wherein the replicating one or more activations in the plurality of segments of activations based on non-zero bits in the first row of bit tiles comprises:
for a segment in one of the plurality of segments, identifying the locations of non-zero bits in each column of the corresponding bit tile;
replicating the activation corresponding to the non-zero bits in each column of the corresponding bit tile in the first row of bit tiles; and
compressing the replicated activations into the one or more first compact rows.

11. The computer-implemented method of claim 10, further comprising:
rotating the plurality of segments in the first row of activations by a size of one segment;
generating one or more second compact rows of activations by replicating the plurality of rotated segments of activations based on non-zero bits in a second row of bit tiles; and
compressing the one or more first compact rows and the one or more second compact rows into a hardware activation buffer for multiplying with the compact weight tensor.

12. The computer-implemented method of claim 1, wherein the weight tensor comprises j columns, and the dividing of the weight tensor into the matrix of tiles includes dividing the j columns into k sections, where k and j are integers, j is divisible by k, and 1<k<j.

13. The computer-implemented method of claim 1, wherein the shuffling of the matrix of tiles in the weight tensor decreases a fanout of each activation for reducing a total wiring distance and a power consumption of a circuit designed for multiplying the weight tensor and the activation tensor.

14. A hardware accelerator for improving computation efficiency in multiplying a weight tensor and an activation tensor at a layer in a neural network, comprising:
a weight tensor compressing circuit configured to:
divide the weight tensor into a matrix of tiles;
shuffle the matrix of tiles in the weight tensor to obtain a shuffled weight tensor; and
remove zero-valued elements in the shuffled weight tensor and pack the non-zero elements in the shuffled weight tensor to obtain a compact weight tensor;
a bitmask generating circuit configured to:
compute a bitmask comprising a matrix of bits corresponding to elements in the shuffled weight tensor, wherein the elements in the shuffled weight tensor includes one or more zero elements and one or more non-zero elements, and each bit from the matrix of bits indicates whether a corresponding element in the shuffled weight tensor is a zero element or a non-zero element;
an activation tensor compressing circuit configured to:
generate a compact activation tensor based on the bitmask and the activation tensor; and
a computing circuit configured to:
perform tensor multiplication based on the compact weight tensor and the compact activation tensor to generate an output tensor of the layer in the neural network.

15. The hardware accelerator of claim 14, wherein the weight tensor is pruned in a way in which a number of non-zero elements in every j continuous elements is within a range between a and b, where j, a, and b are integers, and a<=b<=j, and j equals to a number of rows within one tile.

16. The hardware accelerator of claim 14, wherein to shuffle the matrix of tiles in the weight tensor, the weight tensor compressing circuit is further configured to:
keep a first column of the matrix of tiles unchanged;
rotate a second column of the matrix of tiles along a column-wise direction by a row-size of a tile; and
rotate a third column of the matrix of tiles along the column-wise direction by twice of the row size of the tile.

17. The hardware accelerator of claim 14, wherein the bitmask comprises a matrix of bit tiles respectively corresponding to the matrix of tiles of the weight tensor, and
to generate the compact activation tensor based on the bitmask and the activation tensor, the activation tensor compressing circuit is further configured to:
divide a first row of activations in the activation tensor into a plurality of segments, wherein the plurality of segments respectively correspond to a first row of bit tiles in the matrix of bit tiles;
generate one or more first compact rows of activations by replicating one or more activations in the plurality of segments of activations based on non-zero bits in the first row of bit tiles, wherein the replicating comprises:
for a segment in one of the plurality of segments, identifying the locations of non-zero bits in each column of the corresponding bit tile;
replicating the activation corresponding to the non-zero bits in each column of the corresponding bit tile in the first row of bit tiles; and
compressing the replicated activations into the one or more first compact rows.

18. The hardware accelerator of claim 17, wherein to generate the compact activation tensor based on the bitmask and the activation tensor, the activation tensor compressing circuit is further configured to:
rotate the plurality of segments in the first row of activations by a size of one segment; and
generate one or more second compact rows of activations by replicating the plurality of rotated segments of activations based on non-zero bits in a second row of bit tiles.

19. The hardware accelerator of claim 18, wherein to generate the compact activation tensor based on the bitmask and the activation tensor, the activation tensor compressing circuit is further configured to compress the one or more first compact rows and the one or more second compact rows into an activation buffer for multiplying with the compact weight tensor.

20. A non-transitory computer-readable storage medium, the storage medium storing instructions that, when executed by one or more processors, cause the one or more processors to perform operations comprising:
receiving a weight tensor and an activation tensor at a layer in a neural network;
dividing the weight tensor into a matrix of tiles;
shuffling the matrix of tiles to obtain a shuffled weight tensor;
computing a bitmask comprising a matrix of bits corresponding to elements in the shuffled weight tensor, wherein the elements in the shuffled weight tensor includes one or more zero elements and one or more non-zero elements, and each bit from the matrix of bits indicates whether a corresponding element in the shuffled weight tensor is a zero element or a non-zero element;
removing the zero elements in the shuffled weight tensor and packing the non-zero elements in the shuffled weight tensor to obtain a compact weight tensor;
generating a compact activation tensor based on the bitmask and the activation tensor; and
performing tensor multiplication based on the compact weight tensor and the compact activation tensor to generate an output tensor of the layer in the neural network.
